(19) United States
(12) Patent Application Publication
(10) Pub. No.: US 2023/0385876 A1
(43) Pub. Date: Nov. 30, 2023

(54) COMPUTING SYSTEM FOR TARGETING ADVERTISING AUDIENCES

(71) Applicant: Meshplus Co., Ltd., Taipei (TW)

(72) Inventors: Kuang-Jui Hu, Taipei (TW); Ying-Hsueh Tseng, Taipei (TW); Po-Hsun Wang, Taipei (TW)

(73) Assignee: Meshplus Co., Ltd., Taipei (TW)

(21) Appl. No.: 18/091,135

(22) Filed: Dec. 29, 2022

(30) Foreign Application Priority Data
May 26, 2022 (TW) 111119612

(51) Int. Cl. G06Q 30/0251

(52) U.S. Cl. CPC G06Q 30/0255; G06Q 30/0269

(57) ABSTRACT

The present invention discloses a computing system for targeting advertising audiences, comprising a user data processing module, a user behavior characteristic processing module and a data packaging module. The user data processing module receives a plurality of user data to obtain to-be-analyzed overall data. The user behavior characteristic processing module is connected to the user data processing module, and the user behavior characteristic processing module derives a store active visitor set from to-be-analyzed overall data and a target user group set from a store active visitor set. The data packaging module is connected to the user behavior characteristic processing module, and the data packaging module performs a packaging process on the target user group set to obtain an advertising audience packet and transmits the advertising audience packet to an advertising platform.

### FIELD OF THE INVENTION

The present invention relates to a computing system, and more particularly relates to a computing system for targeting advertising audiences.

### BACKGROUND OF THE INVENTION

In a current marketing and advertising strategy, advertising is mainly performed according to “audience tags” (e.g., gender, age and interest tags) provided by an advertising platform. In other words, most of the current marketing strategies merely depend on the conditions mentioned above to set advertising audiences as potential consumers and advertise to them. However, advertisers cannot know whether the setting rules behind the interest tags of the advertising platform match the behavior characteristics of real consumers, and also cannot perform deeper and more precise audience targeting.

Therefore, the current advertising audiences setting mode cannot fully get the characteristic profiles of the consumer group, and thus cannot precisely target the potential consumers for advertising.

### SUMMARY OF THE INVENTION

Therefore, one objective of the present invention is to provide a computing system for targeting advertising audiences, which targets advertising audiences by filtering specific behavior characteristics so as to guide the advertising platform for advertising, and to increase the advertising effectiveness.

In order to overcome the technical problems in prior art, the present invention provides a computing system for targeting advertising audiences, comprising: a user data processing module receiving a plurality of user data to obtain to-be-analyzed overall data, wherein the user data is corresponding to a user, and the user data contains profile data, website visiting history data and offline point visiting history data, the profile data are gender, age and/or interests of the user, the website visiting history data are a visiting history of websites on which the user has visited, the offline point visiting history data are visiting history of offline points on which the user has personally visited; a user behavior characteristic processing module being connected to the user data processing module, wherein the user behavior characteristic processing module sorts, according to omni-channel store list data, the user data containing the website visiting history data relating to an omni-channel store and the offline point visiting history data relating to the omni-channel store from the to-be-analyzed overall data to obtain a store active visitor set, and the user behavior characteristic processing module sorts, according to data of a target store, the user data containing the website visiting history data relating to the omni-channel store and/or the offline point visiting history data relating to the target store from the store active visitor set to obtain a target user group set; and a data packaging module being connected to the user behavior characteristic processing module and performing a packaging process on the target user group set to obtain an advertising audience packet relating to the target store, wherein the advertising audience packet contains the profile data of all of the user data relating to the target store, the data packaging module transmits the advertising audience packet to an advertising platform, thereby allowing the advertising platform to target the advertising audiences.

In one embodiment of the present invention, a computing system for targeting advertising audiences is provided, wherein the user data further contain a user identification code, which serves as an identifier of the user data corresponding to the user for data processing in the user data processing module.

In one embodiment of the present invention, a computing system for targeting advertising audiences is provided, wherein the user data processing module is connected to an external database to receive the user data from the external database, wherein the user identification code of the user data is obtained by performing a de-identification process on real identity features of the user in the external database.

In one embodiment of the present invention, a computing system for targeting advertising audiences is provided, wherein the user data processing module has a website browsing analysis unit, the website browsing analysis unit performs, according to a domain name format, a data integration process on the user identification code and the visiting history of the websites on which the user corresponding to the user identification code has visited to obtain the website visiting history data.

In one embodiment of the present invention, a computing system for targeting advertising audiences is provided, wherein the user data processing module has an offline point visiting analysis unit, the offline point visiting analysis unit performs, according to a default address data format, a data integration process on the user identification code and the visiting history of the offline points on which the user corresponding to the user identification code has visited to obtain the offline point visiting history data.

In one embodiment of the present invention, a computing system for targeting advertising audiences is provided, wherein the total amount of the plurality of user data is at least 1,000.

In one embodiment of the present invention, a computing system for targeting advertising audiences is provided, wherein the offline point visiting history data of the user data include longitude and latitude data of the offline point on which the user has visited.

In one embodiment of the present invention, a computing system for targeting advertising audiences is provided, wherein the user behavior characteristic processing module has a selection-condition setting unit, the selection-condition setting unit is connected to the advertising platform to receive a target store selecting instruction so that the selection-condition setting unit selects, according to the target store selecting instruction, the user data containing the website visiting history data relating to the target store and/or the offline point visiting history data relating to the target store.

In one embodiment of the present invention, a computing system for targeting advertising audiences is provided, wherein the advertising audience packet further contains data of the omni-channel store on which the user corresponding to the user data relating to the target store has visited.

The computing system for targeting advertising audiences of the present invention has the technical effects as follows. The present invention can precisely target the advertising audiences who have strong consumer intention so that the advertising platform can advertise to target audiences having the specific behavior characteristics, thereby increasing the advertising effectiveness of the advertising platform.

### BRIEF DESCRIPTION OF THE DRAWINGS

FIG. 1 is a block schematic diagram illustrating a computing system for targeting advertising audiences according to one embodiment of the present invention:

FIG. 2 is a schematic diagram illustrating to-be-analyzed overall data of the computing system for targeting advertising audiences according to the embodiment of the present invention;

FIG. 3 is a schematic diagram illustrating that website visiting history data and offline point visiting history data are processed by a user data processing module of the computing system for targeting advertising audiences according to the embodiment of the present invention;

FIG. 4 is a schematic diagram illustrating that a target user group set is obtained from the to-be-analyzed overall data by the computing system for targeting advertising audiences according to the embodiment of the present invention; and

FIG. 5 is a block schematic diagram illustrating a computing system for targeting advertising audiences according to another embodiment of the present invention.

### DETAILED DESCRIPTION OF THE PREFERRED EMBODIMENTS

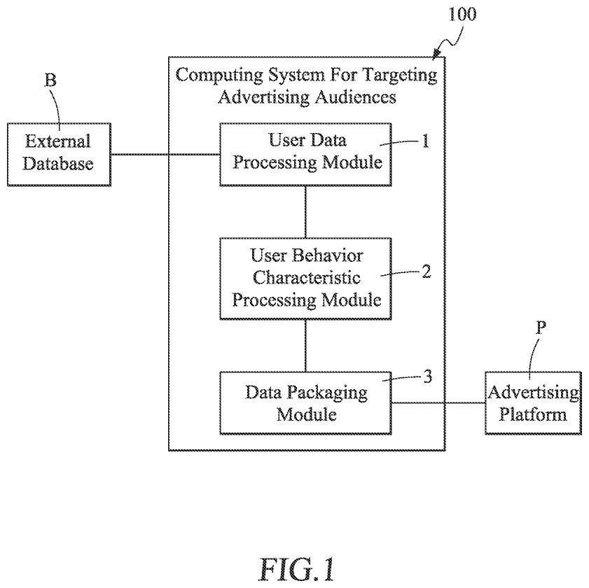

The preferred embodiments of the present invention are described in detail with reference to FIGS. 1 to 5. The description is used for explaining the embodiments of the present invention only, but not for limiting the scope of the claims.

As shown in FIGS. 1, 3 and 4, a computing system for targeting advertising audiences 100 according to one embodiment of the present invention comprises a user data processing module 1, a user behavior characteristic processing module 2 and a data packaging module 3. In this way, the computing system for targeting advertising audiences 100 of the present invention can target advertising audiences by filtering specific behavior characteristics so that the advertising platform can be guided to advertise, thereby increasing the advertising effectiveness.

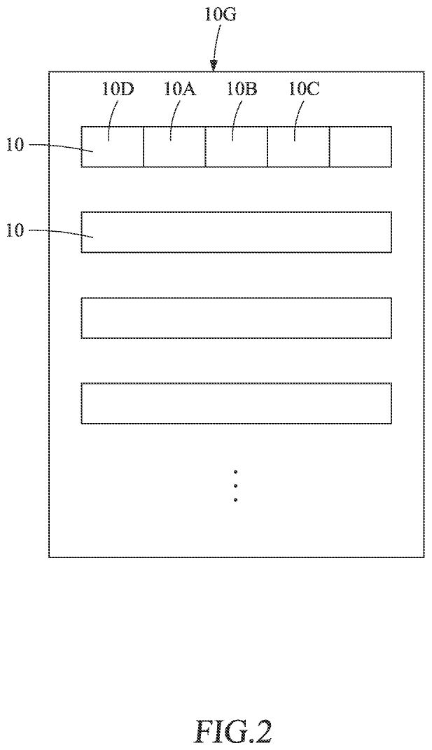

As shown in FIGS. 1 and 2, the user data processing module 1 receives a plurality of user data 10 to obtain to-be-analyzed overall data 10G. Each of the user data 10 is corresponding to a user, and each of the user data 10 contains profile data 10A, website visiting history data 10B and offline point visiting history data 10C. Furthermore, the profile data 10A are gender, age and/or interests of the user. The website visiting history data 10B are a visiting history of websites which the user has visited. The offline point visiting history data 10C are a visiting history of offline points which the user has personally visited.

In detail, as shown in FIG. 2, according to the computing system for targeting advertising audiences 100 of one embodiment of the present invention, the user data 10 further contain a user identification code 10D, which serves as an identifier of the user data 10 corresponding to the user for data processing in the user data processing module 1.

Specifically, as shown in FIGS. 1 to 3, according to the computing system for targeting advertising audiences 100 of one embodiment of the present invention, the user data processing module 1 is connected to an external database B to receive the user data 10 from the external database B. The user identification code of the user data is obtained by performing a de-identification process on real identity features of the user in the external database B. In other words, the present invention performs the data processing and the analysis on the to-be-analyzed overall data 10G without revealing the real identity features of the individual visitor, in compliance with the Personal Data Protection Act. The external database B can be obtained from a telecommunications data provider but not limited thereto.

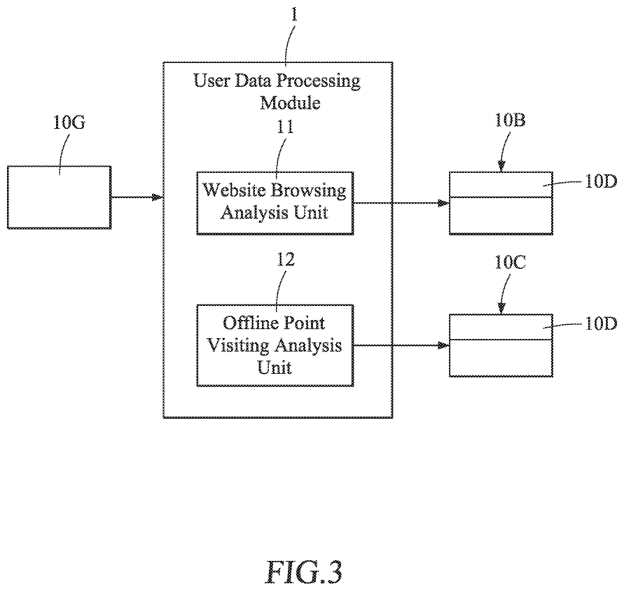

Furthermore, as shown in FIG. 3, according to the computing system for targeting advertising audiences 100 of one embodiment of the present invention, the user data processing module 1 has a website browsing analysis unit 11. The website browsing analysis unit 11 performs, according to a domain name format, a data integration process on the user identification code 10D and the visiting history of the websites which the user corresponding to the user identification code 10D has visited to obtain the website visiting history data 10B.

In addition, as shown in FIG. 3, according to the computing system for targeting advertising audiences 100 of one embodiment of the present invention, the user data processing module 1 has an offline point visiting analysis unit 12. The offline point visiting analysis unit 12 performs, according to a default address data format, a data integration process on the user identification code 10D and the visiting history of the offline points which the user corresponding to the user identification code 10D has visited to obtain the offline point visiting history data 10C, wherein the default address data format contains Arabic numerals, commas and decimal point.

In a specific embodiment of the present invention, according to the computing system for targeting advertising audiences 100 of one embodiment of the present invention, the offline point visiting history data 10C of the user data 10 include longitude and latitude data of the offline point which the user has visited.

Furthermore, according to the computing system for targeting advertising audiences 100 of one embodiment of the present invention, the total amount of the plurality of user data is at least 1,000. In this way, the present invention can prevent the real identity features of the user from being revealed by cross-comparison due to a too small amount of the user to be analyzed.

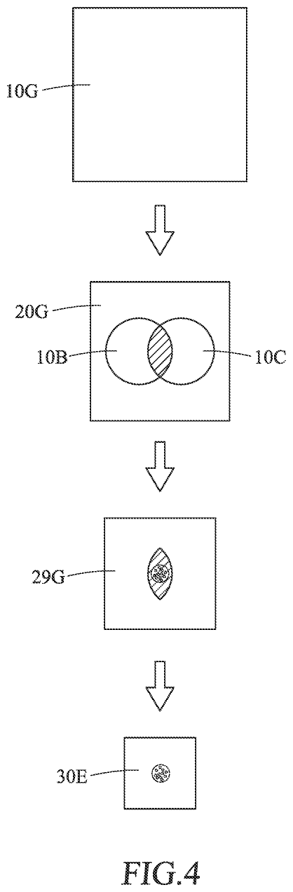

As shown in FIGS. 1 and 4, the user behavior characteristic processing module 2 is connected to the user data processing module 1. The user behavior characteristic processing module 2 sorts, according to omni-channel store list data, the user data 10 containing the website visiting history data 10B relating to an omni-channel store and the offline point visiting history data 10C relating to the omni-channel store from the to-be-analyzed overall data 10G to obtain a store active visitor set 20G, wherein the omni-channel store means a store has websites and offline points. In other words, the sorted users in the store active visitor set 20G have visited any website of a specific omni-channel store and have also visited any offline point of the specific omni-channel store.

Moreover, as shown in FIGS. 1 and 4, the user behavior characteristic processing module 2 sorts, according to a target store designated from the omni-channel store list data, the user data 10 containing the website visiting history data 10B relating to the target store and/or the offline point visiting history data 10C relating to the target store from the store active visitor set 20G to obtain a target user group set 29G. In other words, the users who have visited the target store are sorted from the store active visitor set 20G and classified into the target user group set 29G so as to further streamline the amount of the users so that the characteristic profiles of the users who have the consumer intention for the target store can be identified.

As shown in FIGS. 1, 2 and 4, the data packaging module 3 is connected to the user behavior characteristic processing module 2. Moreover, the data packaging module 3 performs a packaging process on the target user group set 29G to obtain an advertising audience packet 30E relating to the target store, wherein the advertising audience packet 30E contains the profile data 10A of all of the user data 10 relating to the target store.

As shown in FIG. 1, the data packaging module 3 transmits the advertising audience packet 30E to an advertising platform P. Therefore, the advertising platform P targets the target audiences as the advertising audiences to advertise so as to increase the advertising effectiveness of the advertising platform.

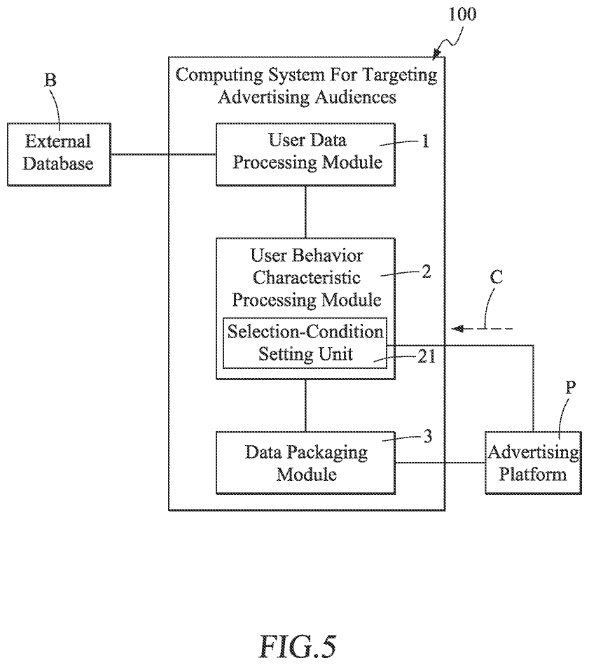

Certainly, the present invention is not limited to the technical means disclosed above. As shown in FIG. 5, according to a computing system for targeting advertising audiences 100A of another embodiment of the present invention, the user behavior characteristic processing module 2 has a selection-condition setting unit 21. The selection-condition setting unit 21 is connected to the advertising platform P to receive a target store selecting instruction C. Furthermore, the selection-condition setting unit selects, according to the target store selecting instruction C, the user data containing the website visiting history data 10B relating to the target store and/or the offline point visiting history data 10C relating to the target store. In other words, the advertising platform P designates the omni-channel stores and the target stores, and the selection-condition setting unit 21 obtains the store active visitor set 20G and the target user group set 29G by gradually filtering for users which meet specific conditions.

Moreover, according to the computing system for targeting advertising audiences 100 of one embodiment of the present invention, the advertising audience packet 30E further contains data of the omni-channel store which the user corresponding to the user data 10 relating to the target store has visited. Therefore, the data of the omni-channel store can be used as an analysis reference for the advertising platform P to advertise to the target user group set 29G.

It can be known from the above that the computing system for targeting advertising audiences 100 uses the user data processing module 1 and the user behavior characteristic processing module 2 to obtain the store active visitor set 20G and the target user group set 29G by filtering the to-be-analyzed overall data 10G so as to further streamline the amount of the users so that potential consumer group having the consumer intention and the characteristic profiles thereof can be obtained. Furthermore, the present invention focuses on the users “who have visited the websites and the offline points” as an analysis focus and considers them as a potential consumer group having strong consumer intention. Therefore, the present invention processes the profile data 10A of the user data 10 in the target user group set 29G relating to the target store to obtain the advertising audience packet 30E and transmits the advertising audience packet 30E to the advertising platform P so that the advertising platform P can target the target audiences as the advertising audiences to advertise so as to increase the advertising effectiveness of the advertising platform. In other words, the present invention can precisely target the advertising audiences who have strong consumer intention so that the advertising platform can advertise to target audiences having the specific behavior characteristics.

The above description should be considered as only the discussion of the preferred embodiments of the present invention. However, a person having ordinary skill in the art may make various modifications without deviating from the present invention. Those modifications still fall within the scope of the present invention.

What is claimed is:

1. A computing system for targeting advertising audiences, comprising:
a user data processing module receiving a plurality of user data to obtain to-be-analyzed overall data, wherein the user data is corresponding to a user, and the user data contains profile data, website visiting history data and offline point visiting history data, the profile data are gender, age and/or interests of the user, the website visiting history data are a visiting history of websites on which the user has visited, the offline point visiting history data are visiting history of offline points on which the user has personally visited;
a user behavior characteristic processing module being connected to the user data processing module, wherein the user behavior characteristic processing module sorts, according to omni-channel store list data, the user data containing the website visiting history data relating to an omni-channel store and the offline point visiting history data relating to the omni-channel store from the to-be-analyzed overall data to obtain a store active visitor set, and the user behavior characteristic processing module sorts, according to data of a target store, the user data containing the website visiting history data relating to the omni-channel store and/or the offline point visiting history data relating to the target store from the store active visitor set to obtain a target user group set; and
a data packaging module being connected to the user behavior characteristic processing module and performing a packaging process on the target user group set to obtain an advertising audience packet relating to the target store, wherein the advertising audience packet contains the profile data of all of the user data relating to the target store, the data packaging module transmits the advertising audience packet to an advertising platform, thereby allowing the advertising platform to target the advertising audiences.

2. The computing system for targeting advertising audiences as claimed in claim 1, wherein the user data further contain a user identification code, which serves as an identifier of the user data corresponding to the user for data processing in the user data processing module.

3. The computing system for targeting advertising audiences as claimed in claim 2, wherein the user data processing module is connected to an external database to receive the user data from the external database, wherein the user identification code of the user data is obtained by performing a de-identification process on real identity features of the user in the external database.

4. The computing system for targeting advertising audiences as claimed in claim 2, wherein the user data processing module has a website browsing analysis unit, the website browsing analysis unit performs, according to a domain name format, a data integration process on the user identification code and the visiting history of the websites on which the user corresponding to the user identification code has visited to obtain the website visiting history data.

5. The computing system for targeting advertising audiences as claimed in claim 2, wherein the user data processing module has an offline point visiting analysis unit, the offline point visiting analysis unit performs, according to a default address data format, a data integration process on the user identification code and the visiting history of the offline points on which the user corresponding to the user identification code has visited to obtain the offline point visiting history data.

6. The computing system for targeting advertising audiences as claimed in claim 1, wherein the total amount of the plurality of user data is at least 1,000.

7. The computing system for targeting advertising audiences as claimed in claim 1, wherein the offline point visiting history data of the user data include longitude and latitude data of the offline point on which the user has visited.

8. The computing system for targeting advertising audiences as claimed in claim 1, wherein the user behavior characteristic processing module has a selection-condition setting unit, the selection-condition setting unit is connected to the advertising platform to receive a target store selecting instruction so that the selection-condition setting unit selects, according to the target store selecting instruction, the user data containing the website visiting history data relating to the target store and/or the offline point visiting history data relating to the target store.

9. The computing system for targeting advertising audiences as claimed in claim 1, wherein the advertising audience packet further contains data of the omni-channel store on which the user corresponding to the user data relating to the target store has visited.
